(19) United States
(12) Patent Application Publication
(10) Pub. No.: US 2025/0058807 A1
(43) Pub. Date: Feb. 20, 2025

(54) CARRIAGE BODY FOR A PASSENGER TRANSPORT VEHICLE

(71) Applicant: Siemens Mobility GmbH, München (DE)

(72) Inventors: Markus Wilhelm, Mönchengladbach (DE); Stefan Schellhaus, Erlangen (DE); Wolfgang Langert, Hamminkeln (DE)

(21) Appl. No.: 18/722,022

(22) PCT Filed: Nov. 21, 2022
(86) PCT No.: PCT/EP2022/082622

§ 371 Date: Jun. 20, 2024

(30) Foreign Application Priority Data
Dec. 20, 2021 (DE) 10 2021 214 650.3

(51) Int. Cl. B61D 17/08; B61D 17/00; B61D 17/12

(52) U.S. Cl. CPC B61D 17/08; B61D 17/005; B61D 17/12

(57) ABSTRACT

A carriage body for a passenger transport vehicle has a carriage body shell which has side walls provided with cut-outs for doors and/or windows, a roof and end walls which are composed of metal structures. The carriage body shell has wall segments which are formed from material through which mobile communication frequencies (frequency f>700 MHz) can pass and are inserted into openings in the metal structures.

The invention relates to a carriage body for a passenger transport vehicle, having a carriage body shell which has side walls provided with cut-outs for doors and/or windows, a roof and end walls which are composed of metal structures.

For example, a carriage body of a rail vehicle for passenger transport is currently manufactured from aluminum or steel, specifically in varying designs, such as integral, differential and hybrid designs. Irrespective of the design, the closed structure of such a carriage body has similar properties with regard to its penetration by radio waves to those of the known Faraday cage, i.e. transmission of radio waves is very poor. The result of this is that the transmitting/receiving properties of mobile radio-based communication devices, such as cell phones, laptops, tablets and so on are considerably worse inside a rail vehicle than outside.

To improve mobile radio reception, there is the approach of using active components, such as a so-called repeater, to emit the mobile radio waves which are emitted by, for example, cell phones which are located in a passenger compartment of the rail vehicle, via an external antenna of the rail vehicle. This solution entails a considerable outlay on additional components.

Furthermore, windowpanes that are particularly permeable to mobile radio frequencies have been developed. This considerably improves the transmission of the mobile radio waves through the vehicle windows, but these advantages are limited to the immediate window area of the vehicles.

Starting from this point, the invention is based on the object of developing a carriage body of the type mentioned at the beginning in such a way that it has an overall improved transmission for mobile radio waves.

In the carriage body described at the beginning, this object is achieved in that the carriage body shell has wall segments which are formed from material that is permeable to mobile radio frequencies (frequency f>700 MHz) and are inserted into openings in the metal structures.

The wall segments of the carriage body shell which are provided and which are permeable to mobile radio frequencies considerably improve the overall transmission behavior of the finished carriage body.

With the aid of the carriage body that is particularly permeable to mobile radio frequencies, for example, windows otherwise designed for mobile radio reception could be replaced by standard glass windows. It is likewise possible that the carriage body that is particularly permeable to mobile radio frequencies is equipped with windows designed to be optimized for mobile radio reception, so that mobile radio reception is improved in the entire carriage body or in parts of the same in which these windows cannot be installed. This is because there are also areas of the carriage in which no windows can be installed in the vicinity.

Windows that are designed to be particularly permeable to mobile radio reception are particularly beneficial for the reception from mobile radio transmitters located at the side. The carriage body presented here could, for example, also permit upward reception/permeability of mobile radio radiation by forming the vehicle roof appropriately.

The selection of materials depends on the respective damping properties for mobile radio frequencies. For example, in Germany, frequency bands in the regions of 800 MHz, 1.8 GHz, 2 GHz and 2.6 GHz are common for the LTE standard. For the upcoming 5G standard, frequency bands around 700 MHz, 3.4 to 3.8 GHz are envisaged.

The metal structures could preferably be in the form of extruded profiles (integral design) or sandwich panels. The envisaged openings into which the wall segments made of material permeable to mobile radio frequencies are to be inserted can be dimensioned to be sufficiently large that they cover a plurality of extruded profiles, for example adjoining one another in the vertical direction of a side wall. Typically, a side wall of a rail vehicle can comprise five extruded profiles, which are each aligned in the longitudinal direction of the rail vehicle and are arranged vertically above one another, wherein adjacent extruded profiles are joined to one another, for example by welding.

The wall segments of the carriage body shell that are permeable to mobile radio radiation are preferably each embedded in a self-supporting support structure. This self-supporting support structure is formed, for example, by suitably positioned openings being created in the solid metal structures, such as extruded profiles or sandwich panels. This can be implemented, for example, by milling. The wall segments of material permeable to mobile radio frequencies are inserted into the openings thus created.

The self-supporting support structure can comprise strut-like support structure elements. These result, for example, from the remains of the metal structures remaining after the milling. In this respect, a strut-like support structure element can be formed from longitudinal sections of extruded profiles adjoining one another vertically and remaining after the milling, or a strut-shaped piece of a sandwich panel. Provision can in particular be made for the support structure to be at least partly formed in the manner of a grid. The self-supporting support structure preferably comprises corner areas of the door and/or window cut-outs. In principle, the wall segments made of material permeable to mobile radio frequencies should be arranged only in statically lowly stressed areas of the side walls, of the roof and of the end walls. Conversely, it is viewed as beneficial that the particularly highly statically stressed corner areas of the door and/or window cut-outs are integrated in the self-supporting support structure.

In this context, it is advantageous if the wall segments made of material permeable to mobile radio frequencies are arranged at a distance from, in particular, corner areas of the door and/or window cut-outs.

In order to achieve the highest possible transmission of the carriage body shell for mobile radio frequencies, the wall segments made of material permeable to mobile radio frequencies should cover a proportion by area of at least 20% of the side wall, of the end wall or of the roof of the carriage body shell. As a basis for the calculation of such a proportion by area, it is possible to use the quotient of a partial outer skin surface, formed from the sum of the outer skin areas of the wall segments made of material permeable to mobile radio frequencies, and a total outer skin surface, including window and door areas and also outer skin areas of the wall segments.

In principle, the proportion by area of the wall segments should be dimensioned such that the result is a desired transmission for the entire carriage body. If sufficient, the proportion by area can consequently fall below the value of 20%.

The material permeable to mobile radio frequencies is preferably metal-free in order to obtain the desired beneficial transmission properties. In particular, the material to be used can be selected from the group which comprises glass fiber-reinforced plastic (GRP) and carbon fiber-reinforced plastic (CFRP).

To join the wall segments made of material permeable to mobile radio frequencies and the adjacent areas of the metal structures, it is possible to fall back on adhesive methods, such as are also used, for example, when installing windows in a carriage body shell. However, it is also possible to screw the wall segments made of material permeable to mobile radio frequencies to the adjacent areas of the metal structures.

An exemplary embodiment of the invention is explained in more detail below with reference to the drawing, in which:

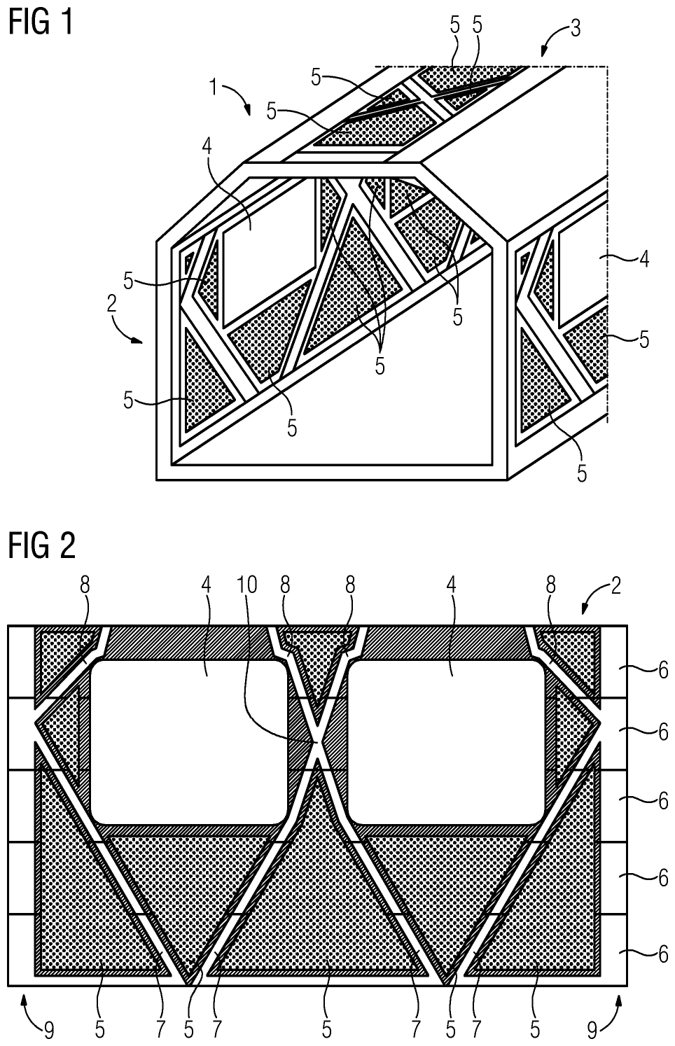

FIG. 1 shows a schematic perspective view of a longitudinal section of a carriage body shell for a rail vehicle, and

FIG. 2 shows a schematic view of a side wall section of the carriage body shell for a rail vehicle according to FIG. 1.

FIG. 1 reveals a carriage body shell 1 of a rail vehicle carriage, which is produced in an integral design, i.e. of which the side wall 2 and roof 3 are constructed from extruded profiles (aluminum) extending in the longitudinal direction of the rail vehicle carriage and welded to one another.

The side wall 2 of the carriage body shell 1 is equipped with window cut-outs 4 in a conventional way. In addition, door openings can be provided, in particular at ends of the carriages.

Wall segments 5 of the carriage body shell 1 are formed from glass fiber-reinforced plastic and inserted into associated openings in the metallic support structure. The outer skin area of the wall segments 5 covers at least 20% of the total outer skin area of the side wall 2. The openings for receiving the wall segments 5 of the carriage body shell 1 have been formed by milling during the production of the carriage body shell 1. This can be done, for example, in one operation with the creation of the necessary door and/or window cut-outs 4. This machining of the initially solid-metal carriage body shell 1 produces a metallic support structure, which is built up from longitudinal pieces of the individual extruded profiles 6 (cf. FIG. 2) which remain after the milling operation.

In terms of its shape, the metallic support structure is present in the form of strut-like lower support structure elements 7 and upper support structure elements 8.

FIG. 2 shows a longitudinal section of the side wall 2. It illustrates that the window cut-outs 4 are each bordered by metallic material. Lower strut-like elements 7 are arranged in such a way that they comprise lower corner areas of the window cut-outs 4. The lower support structure elements 7 extend obliquely upward, approximately from a point on the lower edge of the side wall 2 which is located approximately centrally underneath a window cut-out 4, in the direction of a lower corner area of the associated window cut-out 4 and, from there, until in turn an area 9 of the side wall 2 that is solid metal over the entire height of the side wall 2 or an area 10 that is solid metal arranged between two adjacent window openings 4 is reached. Upper support structure elements 8 adjoin upper ends of the lower support structure elements 7, run in the direction of upper corner areas of the window cut-outs 4 and end at the upper edge of the side wall 2.

As a result of the chosen arrangement of the lower support structure elements 7, the upper support structure elements 8 and the solid-metal areas 9, 10, approximately triangular shapes are formed for the wall segments 5 of glass fiber-reinforced plastic. The wall segments 5 adjoin the window cut-outs 4 laterally and at a distance from corner areas, or are bordered by the support structure elements 7, 8 and solid-metal areas of the side wall 2.

The portions 5 of the carriage body shell 1 are connected to adjacent metallic structures, such as the support structure elements 7, 8, the solid-metal areas bordering the window cut-outs 4 and the areas 9, 10, for example by means of adhesive connections. Alternatively, it is also possible to use screw connections for fastening the wall segments 5 to adjacent metal structures of the aforementioned type.

Although the invention has been explained by using a carriage body for a rail vehicle produced in an integral design and machined from material permeable to mobile radio frequencies to create the openings for the wall segments (5), it can also be implemented in carriage bodies produced in a differential or hybrid design. An application in buses is also conceivable.

In particular, the strut-like support structure elements 7, 8 can also be formed from sandwich panel structures, for example, remaining after milling. Sandwich panels having two metallic cover layers and a likewise metallic honeycomb structure arranged between these cover layers can be used to construct side, end and further walls.

It is also possible for the strut-like support structure elements 7, 8 to be formed from individual profiles and for the construction of the carriage body shell to comprise such individual profiles, sandwich panels and/or extruded profiles, which are suitably joined to one another.

1-11. (canceled)

12. A carriage body for a passenger transport vehicle, the carriage body comprising:
a carriage body shell having side walls with door and/or window cut-outs formed therein, a roof and end walls, said side walls, said roof and said end walls all composed of metal structures with openings formed therein, said carriage body shell further having wall segments formed from a material being permeable to mobile radio frequencies and being inserted into said openings in said metal structures.

13. The carriage body according to claim 12, wherein said metal structures are in a form of extruded profiles or sandwich panels.

14. The carriage body according to claim 12, wherein:
said metal structures include self-supporting support structures; and
said wall segments of said carriage body shell which are permeable to mobile radio radiation are each embedded in one of said self-supporting support structures of said carriage body shell.

15. The carriage body according to claim 14, wherein said self-supporting support structures each include strut-like support structure elements.

16. The carriage body according to claim 14, wherein said self-supporting support structures include corner areas defining said door and/or window cut-outs.

17. The carriage body according to claim 12, wherein said wall segments made of said material being permeable to the mobile radio frequencies are disposed at a distance from corner areas defining said door and/or window cut-outs.

18. The carriage body according to claim 12, wherein said wall segments made of said material being permeable to mobile radio frequencies cover a proportion by area of at least 20% of said side wall, said end wall or said roof of said carriage body shell.

19. The carriage body according to claim 12, wherein said material being permeable to the mobile radio frequencies is metal-free.

20. The carriage body according to claim 19, wherein said material being permeable to the mobile radio frequencies is selected from the group consisting of glass fiber-reinforced plastic and carbon fiber-reinforced plastic.

21. The carriage body according to claim 12, wherein said wall segments made of said material being permeable to the mobile radio frequencies are adhesively bonded into said openings in said metal structures.

22. The carriage body according to claim 12, wherein said wall segments made of said material being permeable to the mobile radio frequencies are screwed to adjacent areas of said metal structures.

23. The carriage body according to claim 12, wherein the mobile radio frequencies are greater than 700 MHz.
